(19) United States
(12) Patent Application Publication
(10) Pub. No.: US 2016/0357940 A1
(43) Pub. Date: Dec. 8, 2016

(54) Systems and Methods for Connected Dispensing and Storage

(71) Applicants: Abraham Carter, Palo Alto, CA (US); David Scott, North Salt Lake City, UT (US)

(72) Inventors: Abraham Carter, Palo Alto, CA (US); David Scott, North Salt Lake City, UT (US)

(21) Appl. No.: 15/065,339

(22) Filed: Mar. 9, 2016

Related U.S. Application Data
(60) Provisional application No. 62/138,870, filed on Mar. 26, 2015.

(51) Int. Cl. G06F 19/00; A61J 7/00; B65D 83/04; H04B 1/3827; H04W 4/00

(52) U.S. Cl. CPC G06F 19/3462; H04B 1/385; H04W 4/008; B65D 83/0409; A61J 7/0076

(57) ABSTRACT

Aspects of the present invention relate to a container for selective dispensing of a contained substance. Some aspects relate to wireless communication connections for communicating container programming data and notifications to a user or third parties. Some aspects relate to selective operation related to the proximity of a wearable component or related to a user's physiological parameters.

### CROSS-REFERENCED APPLICATIONS

This application claims priority benefit to U.S. Provisional Patent Application No. 62/138,870 filed on Mar. 26, 2015.

### BACKGROUND OF THE INVENTION

### 1. Field of the Invention

The present invention relates to a method and apparatus for connected dispensing and storage of substances such as medications, dietary supplements, food products and many other substances.

### 2. Background and Related Art

Currently, a patient or product consumer receives a prescription or recommendation from a doctor or health professional to consume a medication or dietary supplement in a prescribed dosage and frequency for a specified period of time. The patient or consumer then takes the prescription or recommendation to a pharmacist or vendor who dispenses the product, typically in a disposable plastic bottle with a textual description of the contents and the prescribed dosage, frequency and time period.

Under this current scenario, the doctor or health professional and the pharmacist or vendor have no real-time feedback and often no feedback at all related to the efficacy of the prescribed treatment and any adverse reactions of the patient or consumer. Furthermore, health professionals have no way to determine whether the patient or consumer has even consumed the medication or substance in the prescribed quantity or at all.

If a patient or consumer has an allergy or adverse reaction to a medication or substance, an instantaneous response from a health professional can be the difference between life and death.

Furthermore, patients or consumers are often at least partially incapacitated during a treatment scenario. In this condition, they are often not capable of reporting their consumption performance or the effects of the consumed substance on their physiology.

What is needed is a connected, automated container that can communicate with a patient or consumer, communicate with a prescription or recommended consumption database, communicate with health professionals, selectively dispense substances and monitor patient/consumer information.

### BRIEF SUMMARY OF THE INVENTION

A method and apparatus are provided for a connected, automated container with functions comprising communication with a patient or consumer, communication with a prescription or recommended consumption database, communication with health professionals, controlled access and monitoring of consumer physiological and other information.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an exemplary general-purpose computer system;

FIG. 2 shows a representative networked system configuration related to embodiments of the present invention;

FIG. 3 shows a perspective view of a connected container component of an exemplary embodiment of the present invention in the form of a connected medication bottle;

FIG. 4 shows a perspective view of a connected wearable component of an exemplary embodiment of the present invention;

FIG. 5 is a diagram of a first exemplary embodiment of the present invention comprising a direct communication between a mobile device and interested third parties;

FIG. 6 is a diagram of a first exemplary embodiment of the present invention comprising a direct communication between a wearable component and interested third parties; and

FIG. 7 is a diagram of a first exemplary embodiment of the present invention comprising direct communication between a connected container and interested third parties.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

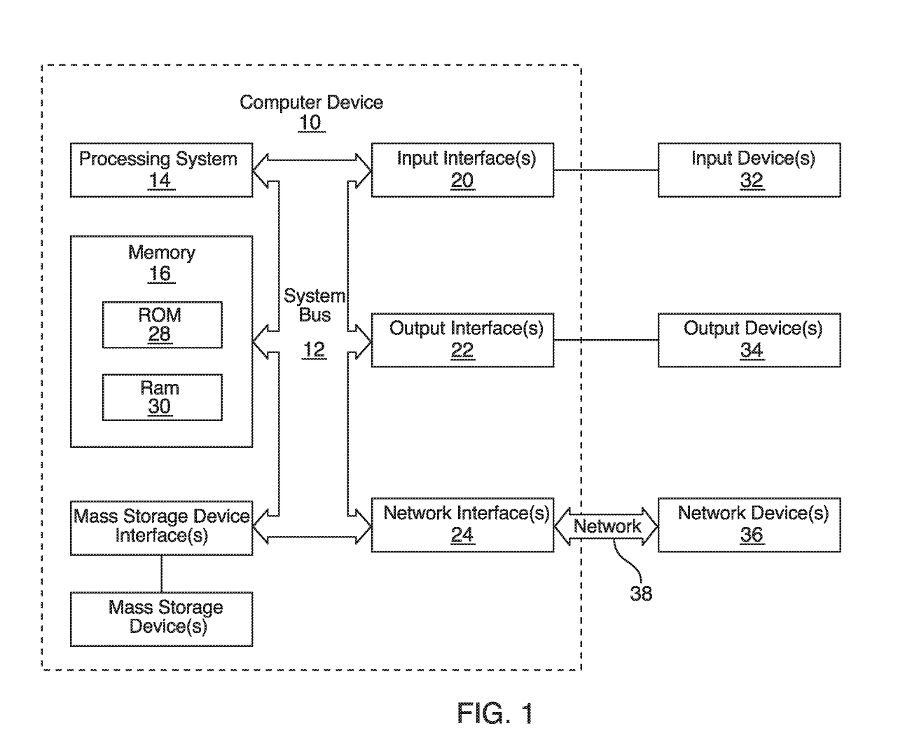

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a fire wire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

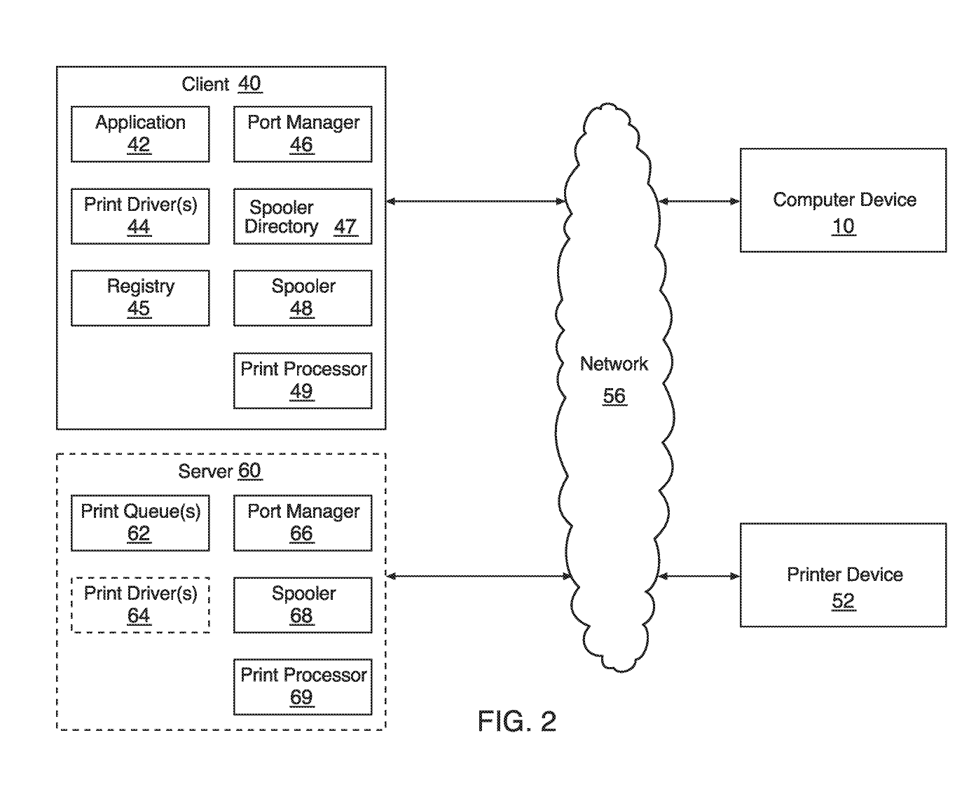

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

To minimize the need to download and/or install programs on users' computers, embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. The exact display of each browser can vary from browser to browser and most are moderately to highly configurable so as to vary the exact display,

Many currently-available browser programs permit the installation of additional features, such as through what are commonly known as “browser extensions.” Browser extensions are becoming more and more common in today's browser programs, and have become one of if not the standard for extending the functionality of the browser programs. For browsers that do not currently support browser extensions, other mechanisms and installed programs are often available to provide similar functionality.

Embodiments of the invention may utilize a browser extension or similar format to provide functions in accordance with embodiments of the invention. The use and installation of a browser extension is typically significantly less involved and less computer-intensive than the use and installation of a stand-alone program. In many instances, the installation of the browser extension occurs essentially without the computer's operating system being made aware of any additional installation. Instead, the browser program itself handles the browser extension and any demands made by the browser extension.

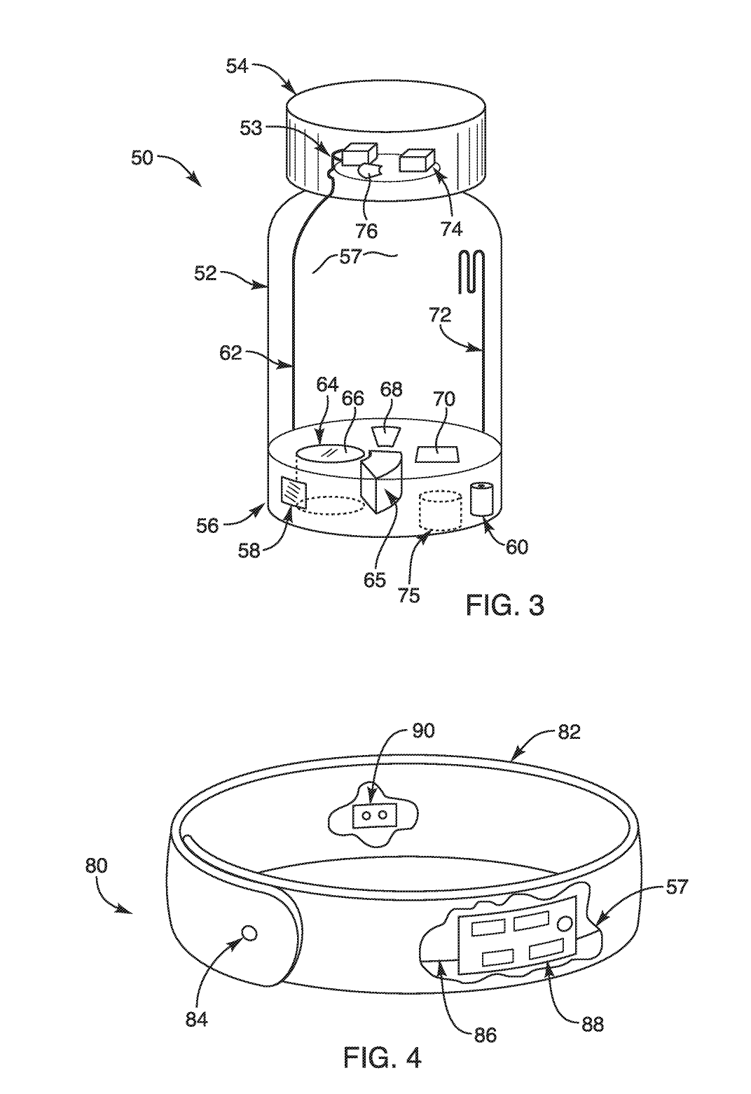

An embodiment of a connected container component of some embodiments of the present invention may be described with reference to FIG. 3. These embodiments comprise a connected container 50 comprising a container wall 52 encompassing a storage volume 51 that may be sealed with a lid 54, such as a screw-top lid or snap-on lid, which may also comprise a lid locking mechanism 53 for selectively locking lid 54 to prevent access to the contents of storage volume 51. Lid locking mechanism 53 may be electronically activated as described below.

Connected container 50 may comprise one or more electronic circuits 70, which may comprise a microprocessor, memory, network communication circuit and other circuits for controlling the functions of connected container 50. The circuits of connected container 50 may be powered by a power source 60 such as a battery. Connected container 50 may further comprise an antenna 72, which may be a patch antenna or another form of antenna and may be located almost anywhere on connected container 50 or lid 54. A communication circuit 70, such as a wireless network controller device may connect electronically and communicatively to antenna 72 for the purpose of wireless communication with a wearable device 80 and or other individuals and devices as described below.

Connected container 50 may also comprise various sensors 76, 58 and emitters 68, 74 for determining the current mass, volume, temperature, orientation and/or chemical composition of the content of storage volume 51. Sensors 58, 76 and emitters 68, 74 may also comprise motion sensors for determining the motion of connected container 50 for the purposes of determining whether connected container 50 has been used in a content dispensing action, has been damaged or has been used to perform an access or ID gesture as described below.

Embodiments of connected container 50 may also comprise an electrical connection 62, such as one or more conductive wires, between the circuits 70 and components 58, 60, 68 of storage volume 51 and lid 54. However, some embodiments may comprise only passive sensors in lid 54, which do not require a direct electrical connection.

A portion of storage volume 51 may be enclosed by a dispensing mechanism 65 comprising a dispensing port 64 and one or more selective dispensing gates 66 for dispensing a pre-determined quantity of the contents of storage volume 51. Dispensing mechanism 65 may comprise further components such as mechanical linkages, gears, rods, gates, springs, shaped orifices, tubes, helical screw drives and other apparatus for selecting and dispensing a specified quantity or volume of pills, capsules, caplets, powdered substances, liquids, gels or other forms of substances. Dispensing mechanism 65 may also comprise electronic circuits, solenoids, servo-motors, electromagnets and other electronic and electrical devices for measuring and dispensing the content of storage volume 51.

Some embodiments of connected container 50 may also comprise a biometric well 75. Biometric well 75 may comprise a depression or orifice for receiving an appendage of a user, such as a finger tip or toe. Biometric well 75 may further comprise sensors, scanners and emitters for measuring biometric or physiological data. Some embodiments of biometric well 75 may comprise a scanner for measuring fingerprint data. Some embodiments of biometric well 75 may comprise a blood oximeter, blood glucose meter or other physiological attribute sensor.

It should be noted that some embodiments of the present invention may comprise all or a majority of the electronic and mechanical components of connected container 50 within the lid 54 as the locations shown in FIG. 3 are merely illustrative.

A wearable component of some embodiments of the present invention may be described with reference to FIG. 4. Wearable component 80 may comprise a wristband, anklet, finger ring, toe ring, belt, necklace, chest strap, arm band, garter, shirt, pants, underwear, bra, headband, shoe clip, wrap, strap, band, adhesive strip, bandage or other clothing or device worn or affixed on a part of the human body.

Some embodiments of wearable component 80 may comprise an adjustable closure 84 for fitting and securing the wearable component 80 to a part of the human body, such as a wrist or ankle. Wearable component 80 may further comprise circuitry 88, 90, which may comprise a microprocessor, memory, motion sensors, other sensors, emitters, antennas, power sources and other circuitry. In an exemplary embodiment, wearable component 80 may comprise motion sensors for detecting 3-dimensional motion of wearable component 80. Some embodiments may also comprise a blood oximeter for detecting blood oxygen levels of a wearer. Some embodiments may comprise an emitter 90 and opposing sensor 88 for emitting a form of radiation, for example red and/or infrared light, and measuring one or more changes in that radiation as it passes through an appendage of the wearer. Some embodiments of wearable component 80 may comprise a pulse sensor. Some embodiments of wearable component 80 may measure detailed heartbeat data for determining heartbeat profiles and volumetric blood flow data.

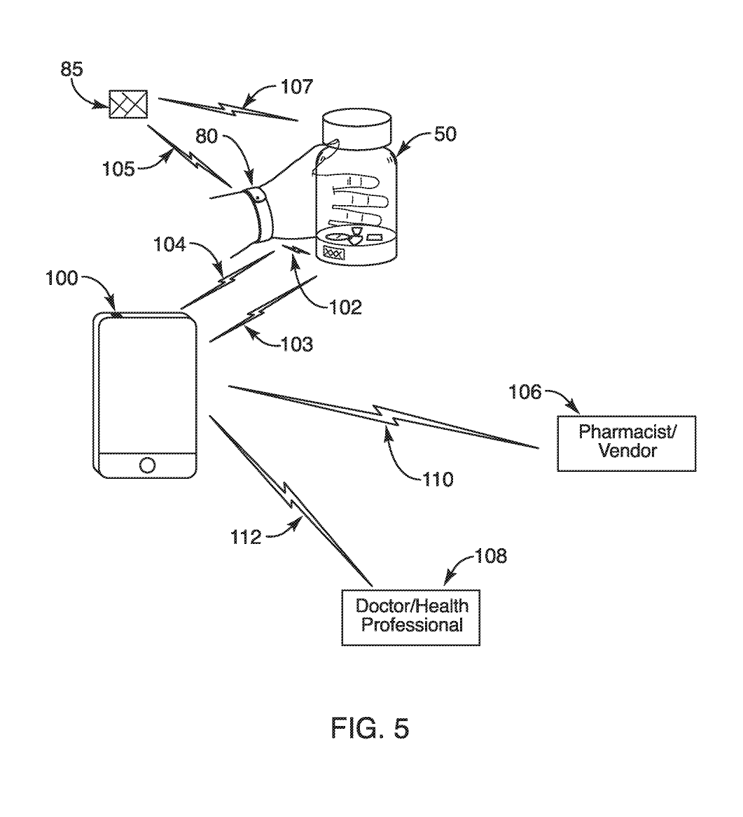

Some embodiments of the present invention may be described with reference to FIG. 5. In these embodiments, an embodiment of connected container 50 is in wireless communication with an embodiment of wearable component 80 via a container-to-wearable wireless communication connection (C/W connection) 102. In some embodiments, there is wireless communication between wearable component 80 and a mobile communication device 100 via a wearable-to-mobile wireless communication connection (W/M connection) 104. In some embodiments, there is wireless communication connection between connected container 50 and a mobile communication device 100 via a container-to-mobile wireless communication connection (C/M connection) 103. In some embodiments, the C/M connection 103 between connected container 50 and mobile communication device 100 may be omitted and data may be passed from connected container 50 through wearable component 80 to mobile device 100 via the C/W and W/M connections 102 and 104. In some embodiments, the W/M connection 104 between wearable component 80 and mobile communication device 100 may be omitted and data may be passed from wearable component 80 through connected container 50 to mobile device 100 via the C/W and C/M connections 102 and 103.

In some embodiments, some processing can be performed at connected container 50 and wearable component 80. However, in some embodiments, processing at wearable component 80 and connected container 50 are minimized and raw data is sent directly 103, 104 to a mobile communication device 100 for processing.

Mobile device 100 may communicate wirelessly with a pharmacist or product vendor 106 via a mobile-to-vendor wireless communication connection (M/V connection) 110. Mobile device 100 may also communicate wirelessly with a doctor or health professional 108 using a mobile-to-professional wireless communication connection (M/P connection) 112.

Wireless communication connections 102, 103, 104, 110 and 112 may be accomplished using IEEE 802.11 (b), (g), (n); Bluetooth, infrared, laser, cell phone or any other standard, protocol or method that allows wireless communication between electronic devices. In some embodiments connections 102, 103 and 104 are accomplished with Bluetooth connections while connections 110 and 112 are performed using a cell phone network.

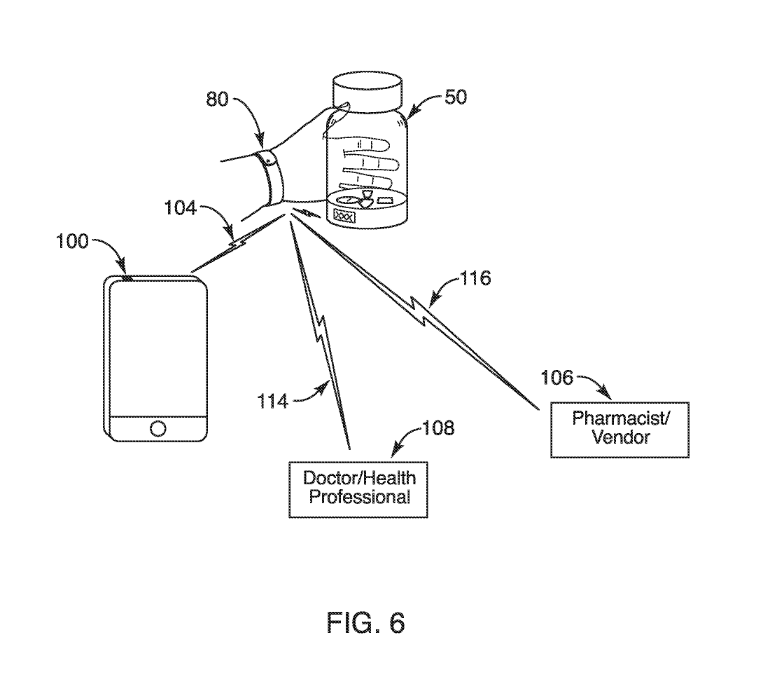

Some embodiments of the present invention may be described with reference to FIG. 6. In these embodiments, a wearable component 80 may establish a wearable-to-vendor wireless communication connection (W/V connection) 116 to communicate with a product vendor or pharmacist 106 directly from the wearable component 80. Some embodiments may comprise a wearable-to-professional wireless communication connection (W/P connection) 114 in order to communicate directly between wearable component 80 and health professional 108.

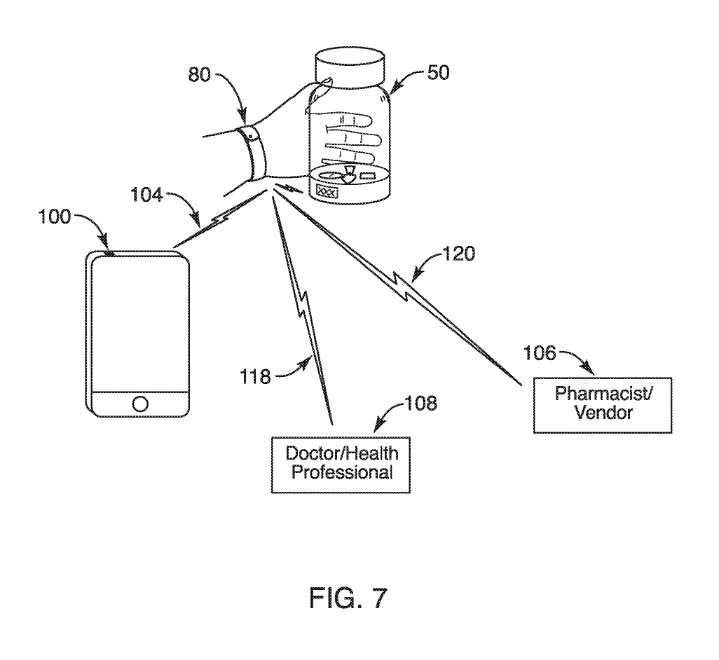

Some embodiments of the present invention may be described with reference to FIG. 7. In these embodiments, a connected container 50 may establish a container-to-vendor wireless communication connection (C/V connection) 120 to communicate with a product vendor or pharmacist 106 directly from the connected container 50. Some embodiments may comprise a container-to-professional wireless communication connection (C/P connection) 114 in order to communicate directly between connected container 50 and health professional 108.

Some functions of embodiments of the present invention may be described with reference to FIGS. 3-7. These embodiments may be used to determine whether a substance has been consumed and whether it has been consumed in a specified quantity as well as physiological monitoring and data reporting. In these embodiments, the lid 54 may be removed and a substance, such as a prescription medication in the form of tablets, may be placed in storage volume 51. This operation may be performed by a pharmacist or vendor 106 depending on the type of substance in use. For substances with a high level of control, the pharmacist/vendor 106 may lock the lid 53 after filling the connected container 50. Once filled, connected container 50 may be programmed to dispense the substance stored inside.

This programming may be performed by a user, a pharmacist/vendor 106, a doctor/health professional 108 or another individual with a connection to connected container 50. In an exemplary prescription drug embodiment, a patient/user receives a prescription from a doctor 108. The prescription may be a hard copy given to the patient or it may be an electronic prescription stored on the patient's mobile device 100, wearable component 80 or connected container 50.

Alternatively, the prescription may be sent electronically to a pharmacist/vendor 106 directly from the doctor 108 (connection not shown). In some scenarios, the patient may have acquired a connected container 50 prior to the doctor's appointment and may have brought it to the doctor for direct programming, in other scenarios, the connected container 50 may be acquired from the pharmacist 106 when filling the prescription.

Connected container 50 may be programmed with a specific prescription or other dosage data. The dosage or prescription programming may be received by direct input at an input device (not shown) on the connected container 50 or preferably by a wireless connection, such as an M/C connection 103, a W/C connection 102, a V/C connection 120, a P/C connection 118 or another wireless connection (not shown). In a typical prescription scenario, a doctor 108 or pharmacist could program the connected container 50 directly over a P/C or V/C connection 118, 120.

Programming data for a connected container 50 may comprise consumption frequency, dosage quantity, consumption start date, consumption termination date, missed consumption protocols (such as double the next dose or extend termination for one consumption period), lock down protocols, alarms, approved supervisory personnel (may be identified by wearables), automated dispensing instructions and other data and/or instructions.

Once a connected container 50 is filled and programmed, the program may be initiated and automated processed may begin. In some embodiments and scenarios, the programming will comprise automated dispensing instructions that instruct connected container 50 to dispense, via dispensing mechanism 65, a prescribed amount of content at intervals identified in the programming data. In some embodiments, dispensing will not occur unless the presence of the patient is verified by the proximity of a wearable component 80 to the connected container 50. In some embodiments, dispensing will not occur unless the presence of approved supervisory personnel is verified by the proximity of a wearable component 80 to the connected container 50.

When dispensing occurs, programming instructs the dispensing mechanism 65 to dispense a specified amount of the substance stored in storage volume 51. For example, 2 tablets, twice a day. In some embodiments, consumption must take place in coordination with meal consumption or other events. In these cases, a patient/user may trigger a dispensing action with a user input, however, programming will control dispensing actions of the dispensing mechanism 65 such that they occur within specified parameters (e.g., twice a day after meals).

In less controlled scenarios or lower cost embodiments without a dispensing mechanism 65, a connected container 50 or wearable component 80 comprising a motion sensor (e.g., 3-D motion sensor) or accelerometer may identify a dispensing activity by its motion signature. For example, when a connected container 50 is in close proximity to a wearable component (e.g., wristband) and the container 50 goes through a dispensing motion while the lid 54 is removed; such as, but not limited to a thrust in a direction axial to the container 50 while the container is substantially horizontal, the container 50 or wearable 80 may record a dispensing action. In some embodiments, the sensor(s) may be located in the container 50 or, alternatively, in the wearable component 80.

In some embodiments, the patient/user can record dispensing action movement while taking doses and store this record for reference by the system. When subsequent dispensing actions occur, the system can identify a dispensing action and record or report that it has occurred at a correct or incorrect interval. United States Patent Application Number 20130282324, Matching System for Correlating Accelerometer Data to Known Movements, by Abraham Carter et al. is hereby incorporated herein by reference.

In some embodiments, a dispensing action can be detected by the container 50 through the use of sensors other than accelerometers. In some embodiments, the quantity of substance stored in storage volume 51 can be monitored and recorded substantially continuously or at intervals. These embodiments, may comprise weight sensors, impedance sensors and other sensors and emitters for measuring the mass, volume, volumetric impedance or other characteristics of the content of storage volume 51. When a reduction in the content of storage volume 51 is detected, the container 50 may record or report the change and may interpret the change as a dispensing action.

In some embodiments, a dispensing action or substance consumption can be verified by a biological response to the consumption as measured by physiological sensors in container 50 or wearable 80. Accordingly, a dispensing action or consumption may be reported or recorded only after verification of a biological response as detected through physiological data capture from container sensors or wearable sensors and interpretation of such data.

Embodiments of the present invention may monitor physiological data with reference to an action, such as a dispensing action or the content of container 50. In particular, changes in a user's physiological data during or immediately after consumption of a medication can be detected, recorded and reported. Physiological data can be monitored using sensors on container 50, such as biometric well 75 and other sensors. Physiological data can also be monitored with wearable component 80 and the sensors 88, 90 therein. In this manner, a patient's response to medication can be monitored remotely and immediate reporting can occur. In some scenarios, an adverse reaction to container content can be automatically reported immediately to a doctor 108 or pharmacist 106 and, if the reaction is severe, emergency response personnel can be contacted automatically and immediately via a connection to mobile device 100 or another connection.

Longer term physiological data can also be used to determine whether sustained use of the content of container 50 has a positive or negative effect on the health of the user. Any changes in physiological data over the term of use of a substance can be recorded and reported with embodiments of the present invention. In some embodiments, these physiological data changes can be reported to a doctor or health professional 108 who may use the data to modify a prescription. In some embodiments, a modified prescription and associated container programming can be sent from the doctor 108 directly to a container 50 over a P/C connection 118, via a wearable 80 over a W/P connection 114, via a mobile device 100 over an M/P connection 112 or by some other connection. In this manner a prescription dosage can be modified in real time based on physiological data feedback from a container 50 or wearable 80 that is reported to a pharmacist/vendor 106 or health care professional 106.

Likewise, some embodiments of the present invention can provide messages and other communication to pharmacists, vendors 106, doctors, health professionals 108, caretakers, supervisors, parents, prison personnel, court-appointed monitoring personnel and anyone else interested in a subject person's consumption of a substance. Similarly, the physiological reaction to the substance consumption can be recorded and reported to the same parties. In some embodiments, the time of consumption and amount consumed can be recorded, compared to prescribed timing and amounts, and reported. In some embodiments, a lack of prescribed consumption can be recorded and/or reported.

In some embodiments, a patient-specific physiological model can be used to determine whether a substance is being abused or has an adverse effect on a patient.

In some embodiments of the present invention, lid locking mechanism 53 may be selectively operated in response to the proximity of wearable component 80, positive ID of a user from biometric data measured in biometric well 75, proximity to mobile device 100 or some other user ID scheme.

Lid locking mechanism 53 may also be selectively operated in response to a motion gesture as detected by wearable component 80 and/or container 50. In these embodiments, container 50 may be locked using lid locking mechanism 53, which may be programmed to open only when a user performs a specified motion sequence as detected by motion sensors in container 50 or wearable 80. In some embodiments, the proximity of wearable 80 to container 50 may be required during performance of the motion sequence. For example, lid locking mechanism would allow removal of lid 54 thereby providing access to the content of storage volume 51 only within 10 seconds of performing a prerecorded figure eight motion sequence while wearable 80 is within one foot of container 50. These embodiments can provide child-proof and tamper-proof protection while allowing arthritic or otherwise physically-challenged users to easily remove lid 54 after the unlocking sequence without having to forcefully unscrew a tightened cap as with traditional child-proof caps.

Lid locking mechanism 53 may also be selectively operated based on a time of day, date, physiological condition or other parameters. In some embodiments, lid locking mechanism 53 may only allow access to the contents of storage volume 51 at specific times, dates and/or physiological conditions identified by prescription program data. For example, lid locking mechanism 53 may unlock lid 54 only at specific times of the day when a prescription is to be consumed. Additionally, lid locking mechanism 53 may provide access to contents only when a patient has a specific physiological condition, such as a low blood glucose level, low blood oxygen level, low heart rate or some other physiological condition as identified by sensors in wearable 80 and/or container 50.

Some embodiments of the present invention may comprise visual, audio or tactile alarm indicators (not shown) such as LED lights, ringers, speakers, vibrators or other devices. These embodiments can be programmed with prescription or consumption data to remind a user to consume the content of container 50 at a specified time or time period. Some embodiments may also inform other parties 106, 108 by messaging over one or more wireless connections 102, 103, 104, 110, 112, 114, 116, 118, 120 that an alarm has been triggered by non-consumption of content. In some embodiments, multiple alarm scenarios may be used to give a user several chances to respond before other parties are notified.

Some embodiments of the present invention may be used to dispense items such as alcohol, food products, jewelry, prescription and over-the-counter (OTC) drugs, car keys and other products.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. An apparatus for selectively dispensing content, said apparatus comprising:
a container comprising,
an enclosed storage volume,
a selectively-lockable lid,
a processor and memory for operating said lid,
a wireless transceiver, and
a proximity sensor;
a wearable component comprising,
a motion sensor, and
a wireless transceiver;
wherein said lid can be unlocked only when said proximity sensor senses a close proximity of said wearable component.

2. An apparatus for selectively dispensing content, said apparatus comprising:
a container comprising,
an enclosed storage volume,
a selectively-lockable lid,
a processor and memory for operating said lid, and
a wireless transceiver for receiving instructions for operating said lid.

3. The apparatus of claim 2, wherein said transceiver sends use information.

4. An apparatus for selectively dispensing content, said apparatus comprising:
a container comprising,
an enclosed storage volume,
a selectively-lockable lid,
a processor and memory for operating said lid,
a physiological data sensor; and
a wireless transceiver for receiving instructions for operating said lid.

5. The apparatus of claim 4, further comprising instructions for operating said lid wherein said instructions keep said lid locked except for during the occurrence of a specified physiological condition.

6. An apparatus selectively dispensing content comprising:
an enclosed storage container;
a lid;
a dispenser configured to release a predetermined amount of material from the enclosed storage container; and
a processor and memory for controlling the dispenser.

7. An apparatus as set forth in claim 6, further comprising a selectively lockable lid to secure the contents of the enclosed storage container after filling.

8. An apparatus as set forth in claim 6, further comprising a wireless transceiver capable of receiving wirelessly instructions regarding the amount and frequency of material to dispense and capable of controlling the dispenser.

9. An apparatus as set forth in claim 7, wherein said wireless transceiver sends information from said apparatus concerning the amount of the remaining material by subtracting the amount of material dispensed from a total of material when the apparatus was filled.

10. An apparatus as set forth in claim 9, further comprising a scale.

11. An apparatus as set forth in claim 10, wherein said wireless transceiver is connected to said scale to transmit the current remaining quantity of material.

12. An apparatus as set forth in claim 6, further comprising a display showing the dose and time for activating the apparatus to dispense some of the material from the apparatus.

13. An apparatus as set forth in claim 6, further comprising a wearable component and wherein said apparatus will not dispense material without the wearable component being sensed as within close proximity to the apparatus.

14. An apparatus as recited in claim 13, further comprising a carousel containing several different materials such as medications located within the enclosed storage container and controlling by the processor to interact with the dispenser to dispense a preset quantity of several materials at the same time.

15. An apparatus as recited in claim 14, wherein the carousel cooperates with the dispenser and processor to dispense a preset quantity at preset times of the day.

16. An apparatus as recited in claim 15, wherein the transceiver is capable of receiving instructions to alter the amount and timing of material to be dispensed.

17. An apparatus as recited in claim 6, wherein said dispenser counts and records the amount and timing of material dispensed.

18. An apparatus as recited in claim 17, wherein the dispenser has a motion detector that records motions created during a dispensing event.

19. An apparatus as recited in claim 18, wherein said motion detector is an accelerometer.

20. An apparatus as recited in claim 13, wherein said apparatus has a transceiver in communication with the wearable device and the wearable device measures and monitors biological responses to administration of the dispensed medication to verify that the patient has consumed the dispensed medication.

21. An apparatus as recited in claim 20, wherein said monitoring of a biological response occurs over a period of time and reported so that a determination may be made whether prolonged use of a medication is providing a positive effect upon the biological response of a user.

22. An apparatus as recited in claim 20, wherein information about the biological response of a user is transmitted to a health care professional.
